(19) United States
(12) Patent Application Publication
(10) Pub. No.: US 2014/0157256 A1
(43) Pub. Date: Jun. 5, 2014

(54) OWNER/USER-DRIVEN CONTROLLED DISTRIBUTION OF SOFTWARE FOR MOBILE DEVICES AND PERSONAL COMPUTER THROUGH A PRIVILEGED PORTAL

(71) Applicant: DONOTGEOTRACK, Atherton, CA (US)

(72) Inventors: Charles T. Marshall, Atherton, CA (US); Donald Henry, Menlo Park, CA (US)

(73) Assignee: DONOTGEOTRACK, Atherton, CA (US)

(21) Appl. No.: 14/093,439

(22) Filed: Nov. 30, 2013

Related U.S. Application Data
(60) Provisional application No. 61/732,257, filed on Nov. 30, 2012.

(51) Int. Cl. G06F 9/445

(52) U.S. Cl. CPC G06F 8/61
USPC 717/178

(57) ABSTRACT

A business process links several interrelated technological processes that allow a user or an owner to control the scope of applications or programs downloaded to a device by linking 1) an application or program rating system to 2) custom filters that screen out applications or programs not meeting the criteria defined by the user or owner to 3) a lock-down feature which warns, discloses, or impedes downloads or installation of applications not meeting the filter criteria to 4) an application or program removal system that removes or alerts users or owners of the presence of disables applications or programs that are either no longer consistent with user or owner expressed preferences because of a change of those preferences or a re-rating of or change in the application or program.

### CROSS REFERENCE TO RELATED APPLICATIONS

The present application relates to and claims priority of U.S. provisional patent application (“Copending Provisional Application”), Ser. No. 61/732,257, entitled “OWNER/USER-DRIVEN CONTROLLED DISTRIBUTION OF SOFTWARE FOR MOBILE DEVICES AND PERSONAL COMPUTERS THROUGH A PRIVILEGED PORTAL,” filed on Nov. 30, 2012. The disclosure of the Copending Provisional Application is hereby incorporated by reference in its entirety.

### BACKGROUND OF THE INVENTION

1. Field of Invention

The present application relates to electronic sale or free distribution of software (e.g., application programs and other types of programs, collectively “programs”) for mobile devices or personal computers. The present application also relates to a screening system which allows users or owners of these devices to decide upon and to implement standards on what is permitted to be downloaded and maintained on the devices. Such a screening system may be implemented using a privileged portal for application or program distribution.

2. Discussion of the Related Art

Users or owners of mobile devices and personal computers are offered a very large number of application or other types of programs (“apps”) for them to download to their equipment. For example, the numbers of apps in the Apple™ and Android™ families of devices are each well over half a million. Users or owners may have many reasons for wanting to restrict the scope of apps that may be downloaded to their devices. Some reasons include: (a) a user desire for apps which respect the users' or owners' privacy rights in their data (e.g., geolocaton) that are contained on or generated by the device; (b) parents may wish to restrict their children from downloads that link them to inappropriate forums (e.g., those frequented by pedophiles) or content (e.g., games, especially violent or sexually explicit games, and pornography); (c) employers may wish to restrict software downloads on devices supplied by them to software that is related to workplace productivity; and (d) users may wish to restrict downloads to programs which have proven reliability or safety. A need therefore exists for tools that owners or users may use to make decisions about the software downloaded to their machines and to implement these decisions.

### SUMMARY OF THE INVENTION

The present invention links several processes or technologies together to allow an owner or user of a device (e.g., a mobile device or a personal computer) to control what is downloaded to the device and to monitor the device to help enforce the desired control.

According to one embodiment of the present invention, a user or owner of the device installs code (hereinafter, a “master program”) which creates a privileged relationship between that device or computer and a dedicated portal (a “privileged portal”) for downloading other programs. From the device or through a secure internet site, the owner or user defines a set of criteria for programs he or she wishes to allow on the device. These criteria may conform, in structure and values, to a rating system for software. The privileged portal then filters the available programs, dividing the programs into two categories: those that are compliant with the owner's or user's expressed preferences and those that are not compliant. When a user attempts to download or install a program on the device, the master program manages that action. If the user attempts to download a program from any source other than the privileged portal, the master program prevents such a download, alerts the user and or owner of the attempt to download from a non-privileged portal, allows an override to permit the download from the non-privileged portal, or takes a combination of these actions. Alternatively, when the user goes to the privileged portal, that portal displays and allows download of those programs that are compliant with the user's or owner's expressed preferences, blocks download of non-compliant programs, notifoes the owner or user of an attempt to download a non-compliant program, allows an override by the owner and or user of the block, or takes any combination of these actions. The master program also monitors the device for presence of programs that are no longer compliant with the owner/user expressed preferences (e.g., because of revised software, revised ratings, or revised owner/user preferences). Upon finding a non-compliant program on the device, the master program disables or removes such a program, alerts the owner or user to the presence of such a program, allow the owner or user to override the disabling or removal of the program, or take a combination of such actions.

The privileged portal interacts with vendors of software in ways so that it may present both the software and formatted information about that software to owners and users. The processes that work with the vendors of software are 1) vendors making programs available through the privileged portal, 2) establishment of a basis for rating programs in the form of formatted information, and 3) maintenance of the information that is used for the rating.

The present invention is better understood upon consideration of the detailed description below, in conjunction with the drawings.

### BRIEF DESCRIPTION OF THE DRAWINGS

FIG. 1 provides an overview of a process for an owner or user, according to one embodiment of the present invention.

FIG. 2 illustrates rating programs according to one or more criteria, according to one embodiment of the present invention.

FIG. 3 illustrates a process by which a user or owner declares his or her preferences, according to one embodiment of the present invention.

FIG. 4 illustrates a process by which programs are filtered based on user or owner preferences, according to one embodiment of the present invention.

FIG. 5 illustrates a process by which a privileged portal hides, disables, or highlights programs not conforming to compliance criteria, according to one embodiment of the present invention.

FIG. 6 illustrates the master program blocking a non-compliant download, according to one embodiment of the present invention.

FIG. 7 illustrates the master program alerting an owner or user to a non-criteria download, according to one embodiment of the present invention.

FIG. 8 illustrates the master program notifying an owner or user of a non-compliant download, according to one embodiment of the present invention.

FIG. 9 illustrates the master program notifying the owner or user of, and blocks, a non-compliant download, according to one embodiment of the present invention.

FIG. 10 provides an overview of a process for software vendors, according to one embodiment of the present invention.

### DETAILED DESCRIPTION OF THE PREFERRED EMBODIMENTS

Both users and owners of mobile devices and personal computers¹ have been offered an enormous number of applications and programs.² There are more than 700,000 applications available for the Apple™ family of mobile devices and there are more than 675,000 available for Android™ devices.³ Program counts for personal computers are more difficult to establish as there are many more outlets through which these products can be sold. Users may have an interest in avoiding applications and programs that impinge on their personal privacy, that include malicious code, or that are written so poorly that they may decrease the reliability of their equipment. Owners, when distinct from user, have other interests. Parents may wish to prevent their children from downloading applications and programs associated with forums or portals frequented by pedophiles. They may also wish to restrict their children from downloading violent or sexually explicit games (or games altogether). Employers may wish to restrict downloads to company provided equipment to productivity enhancing software or applications. ¹While mobile phones and personal computers previously were viewed as distinct products, the differences between them have been blurred by the capabilities of so-called “smart” phones which incorporate some of the capabilities of personal computers and various “pads” which bridge the differences. The term “mobile devices and personal computers” is used here to refer to the entire continuum of products.

² Software for mobile devices is normally referred to as “applications” while software for personal computers is normally referred to as “programs.” In this detailed description, the term “applications and programs” and more generally just “programs,” refers to any software written for any of the devices discussed herein.

³“Google Android store reaches 25 billion downloads, 675,000 apps,” AppleInsider.com, Sep. 26, 2012.

### Process for Owners/Users

Previous methods for controlling the characteristics of allowable applications and programs installed on a device are either exhaustive (i.e., the time-consuming process of a user or owner reviewing the characteristics of each piece of code before it is installed on the device), or through the form of “permission by exception”⁴ approach. Neither

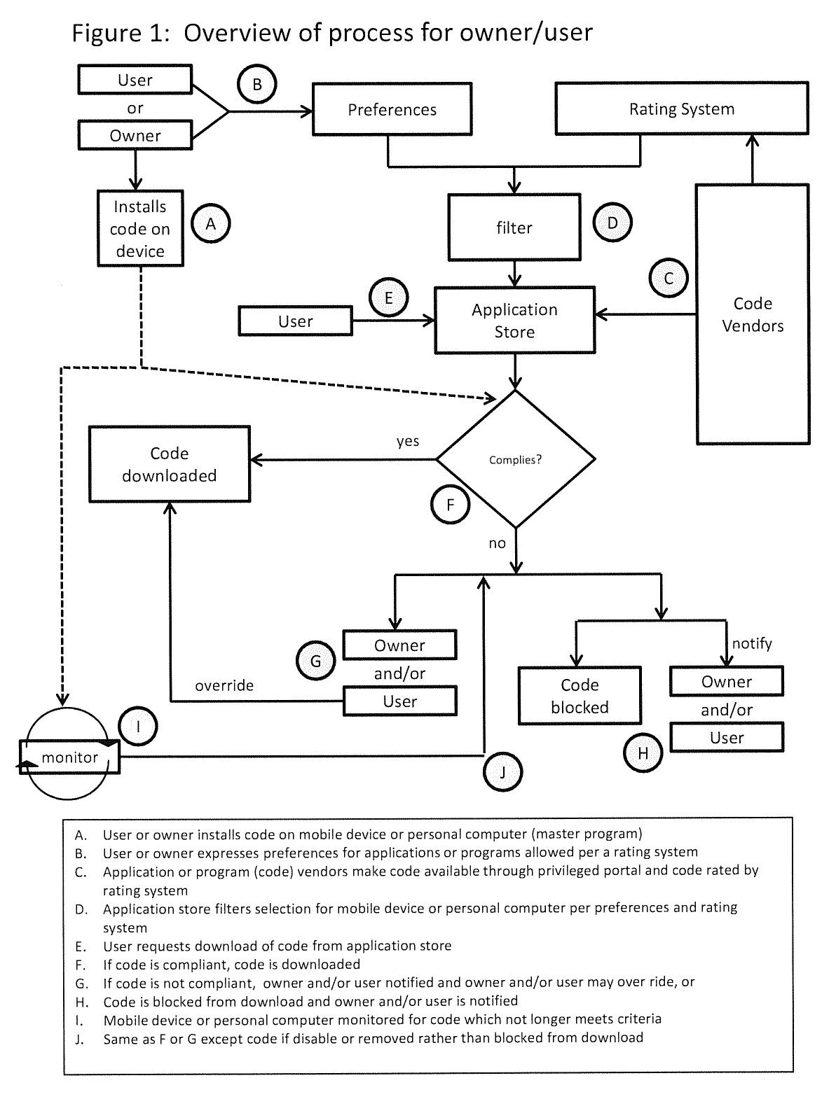

⁴ “Permission by exception” refers to a process in which all actions of a type, downloading software in this instance, are prohibited unless allowed individually. approach is efficient. The exhaustive approach is limited by the time, patience, and technological prowess of the user or owner. The second approach unnecessarily prevents users from readily accessing the full range of software that simultaneously improve device functionality and advance the interests of the owner. The present invention adopts a “restriction by exception” control mechanism,⁵ and is very efficient. A user or an owner defines his or her criteria for applications and programs they are allowed to be downloaded, and the process restricts downloads to compliant applications and programs, alerts the user or owner that an application or program may not be compliant, notifies the owner of an attempt or actual download of a non-compliant application or program, scans the device regularly for non-compliant applications or programs, and takes appropriate actions when such non-compliant software is found. FIG. 1 provides an overview of this process. (In this detailed description, while the owner and the user may be the same person, where appropriate, they may be regarded as being separate. This is because the owner and the user may have different interests, such as between a parent and his or her child, and between an employer and an employee). ⁵“Restriction by exception” refers to a process in which all actions of a type are all allowed unless specifically prohibited.

As shown in FIG. 1, in step A, the owner or user installs code (the “master program”) on the mobile device or personal computer which, 1) manages the download and installation of applications or programs from online portals (i.e. application stores, etc.), 2) creates a privileged relationship between the device and a particular portal, 3) takes specific actions when a user attempts to download applications or programs, and 4) periodically scans the device for applications or programs with certain characteristics and takes action when such code is found.

In step B, the owner or user of the mobile device or personal computer accesses a privileged portal, either from the device itself or through a secure internet site. At the privileged portal, the owner or user expresses preferences on the characteristics of software or applications that are acceptable on the device.

In step C, vendors of code (i.e., applications or programs) provide access to code for free or sale through the privileged portal. A rating system rates each application or program consistent with the same system in which the criteria expressed by the owner or user are expressed in Step B. The rating system may depend on continuous, discrete, or even calculated variables, but the structure, meaning, and typology of the ratings variables match those used in the privileged portal.

In step D, the privileged portal compares the owner/user expressed criteria to the characteristics evaluated in the rating system. It provides a customized bifurcation of applications and programs available through the portal into those compliant with the owner/user preferences and those not compliant.

Step E concerns a user's attempt to download and install an application or program on to their device. When the user attempts to use an application or program at a portal other than the privileged portal (i.e., an alternative portal), the master program takes action according to settings determined by the device owner. The master program may block access to the alternative portal, it may allow access to the alternative portal through an override process activated by the user, it may allow access to the alternative portal through an override process activated by the owner, or it may merely notify the owner or user that compliance with the owner expressed criteria cannot be ensured with using the alternative portal.

When the user attempts to download from the privileged portal, the master program will compare the requested download to the owner expressed preferences in Step F. If the requested download is compliant, it is allowed. If it is not compliant, one of several owner-determined paths are taken.

If the owner has configured the master program appropriately, step G allows the owner or user (as determined by the owner) to override the owner-determined criteria and explicitly allow the download of the software or application.

Alternatively, in step H, if configured by the owner, the master program blocks any download that is not consistent with the criteria set by the owner. Again, according to preferences set by the owner, the master program notifies the owner and or the user of any attempted non-compliant download.

In step I, the master program periodically scans the device for applications or programs which are not consistent with the criteria set by the owner. Such a situation may arise if 1) the owner changes the criteria desired for the device, 2) the rating for the application or program has changed, or 3) the user or a malevolent actor has somehow bypassed the master program controls.

When non-compliant code (other than code permissioned by an override) is found on the device, the master program, in step 1, takes actions akin to those in step H or I, depending on settings determined by the owner. It may provide an owner or user override to allow the application or program to remain on the device, removing or disabling it otherwise. Alternatively, it may automatically remove or disable such application or program, notify the user, the owner, or both.

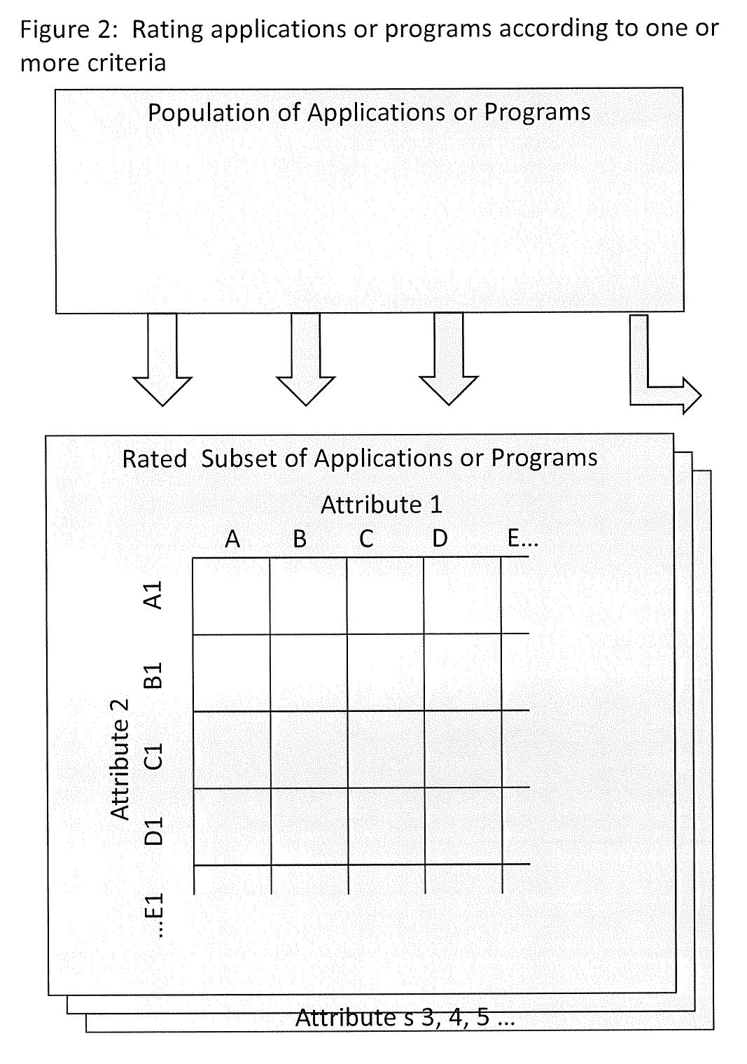

FIGS. 2 through 9 show illustrative examples of how this technology may be implemented. FIG. 2 shows a rating scheme which may be used for applications or programs. The criteria displayed here are all discrete (i.e. does this software track the user's location? Is the dependability of the coding low, medium, or high? Is this a violent game?). Continuous variables may be used as criteria (i.e. Is the cost above or below an owner determined threshold?). A simple calculated criterion may allow geotracking on free software but disallow it on software with a monetary cost.

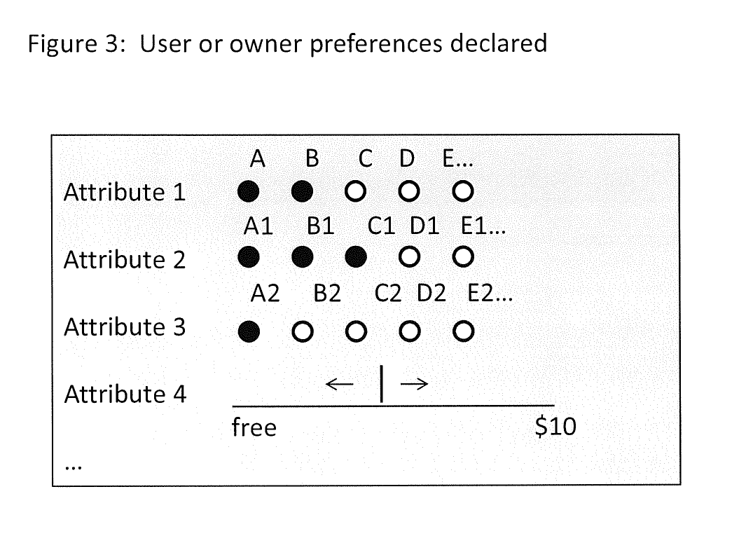

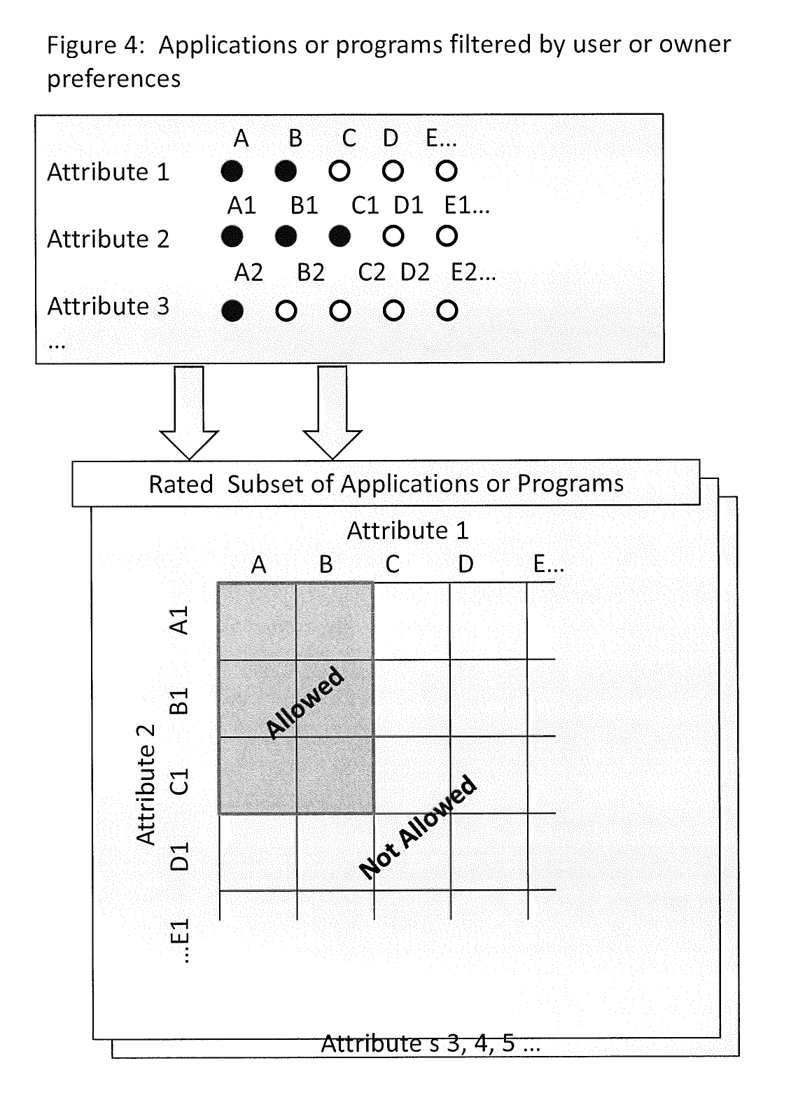

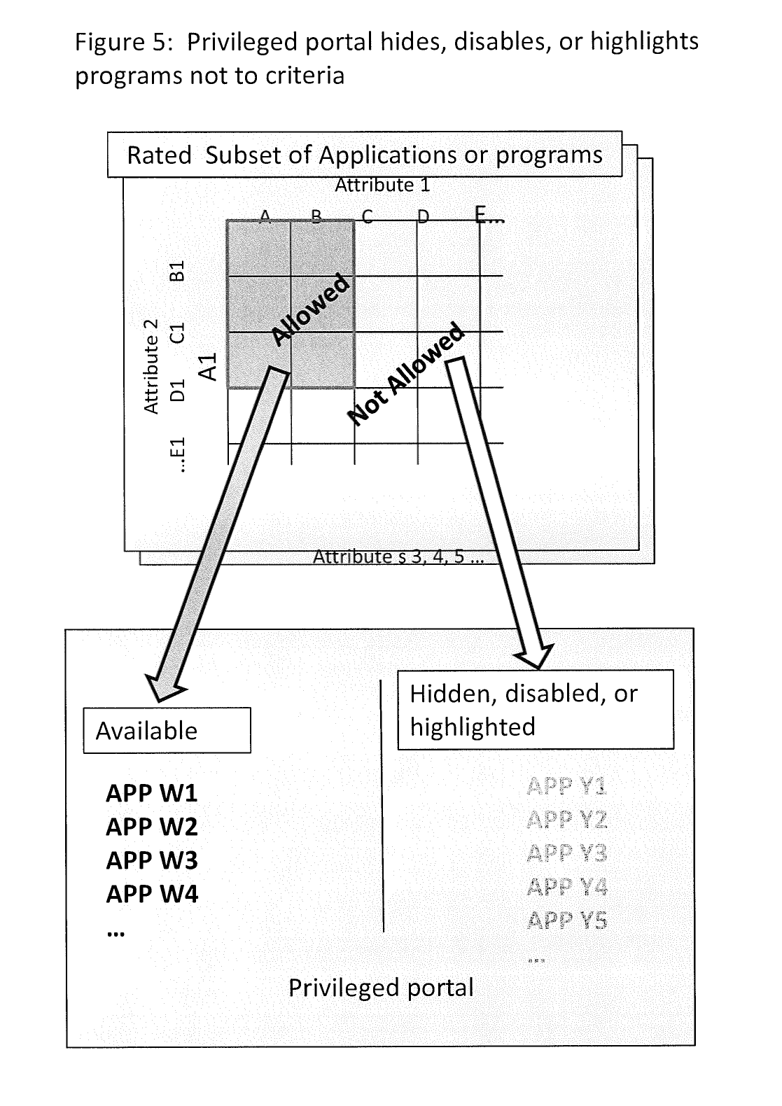

FIG. 3 shows a rudimentary example of a portal where an owner can express his criteria for permitted applications or programs. It displays three discrete variables and one continuous one. FIG. 4 overlays these preferences on the ratings the software or application have received. FIG. 5 shows a basic example of how the portal may differentiate the compliant applications or programs from non-compliant ones.

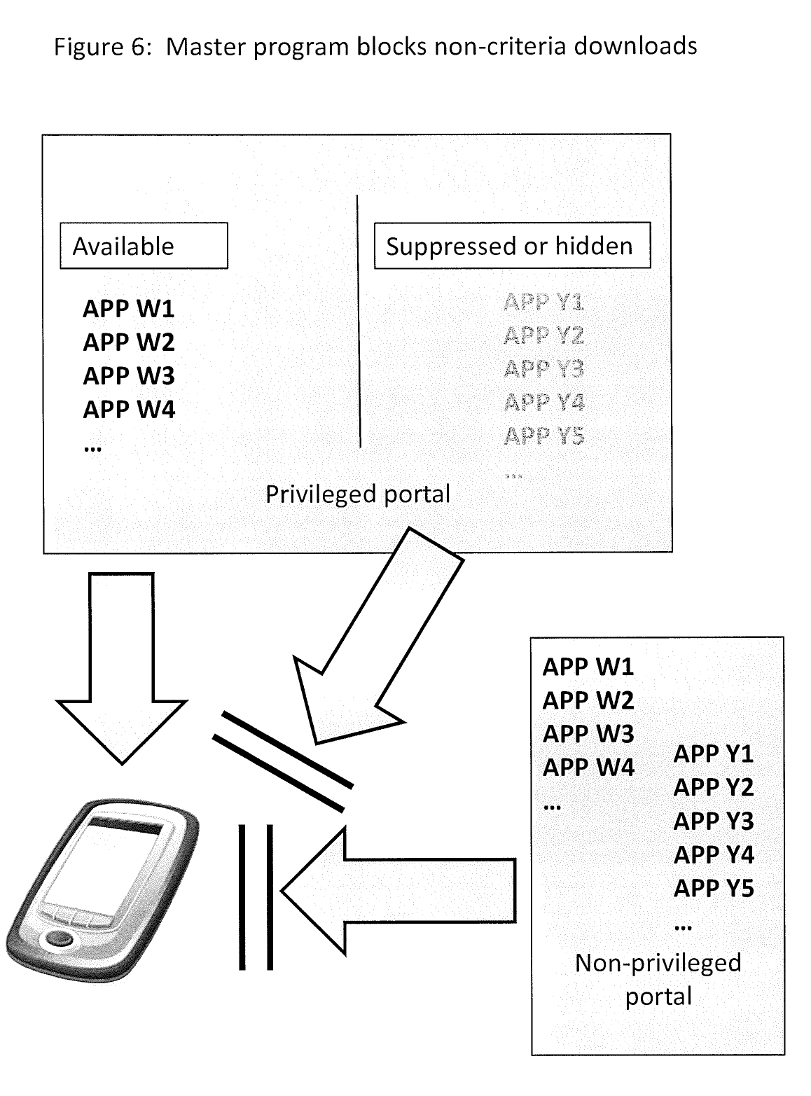

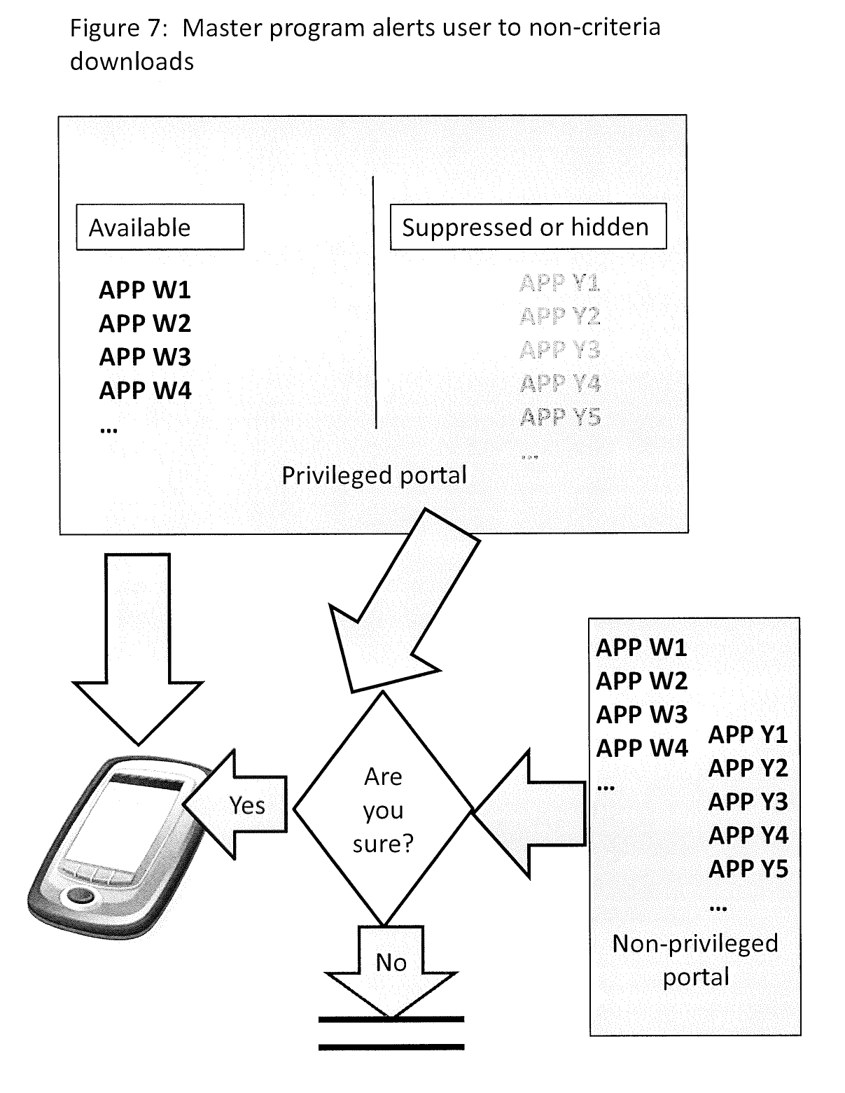

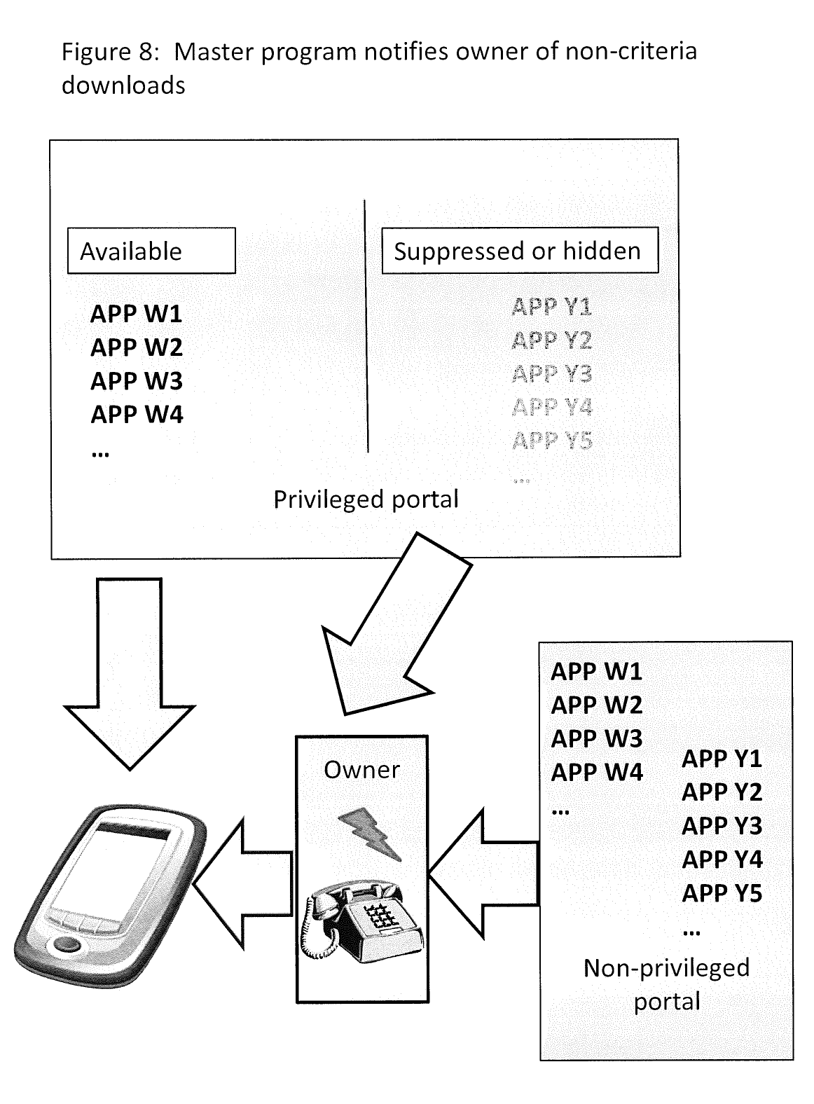

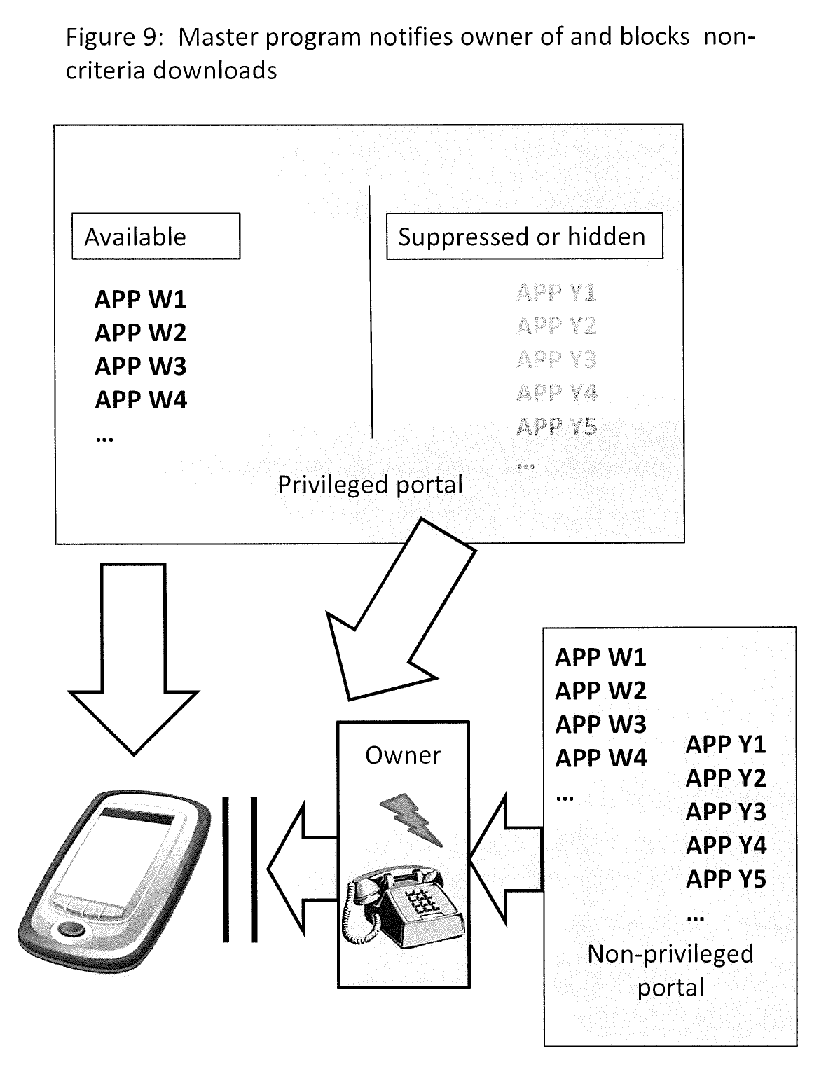

FIGS. 6, 7, 8, and 9 are illustrative examples of how the master program may handle attempts to download non-compliant applications or programs. In the simplest example, FIG. 6 shows compliant software from the privileged portal allowed, non-compliant applications or programs and any applications or programs not from the privileged portal blocked. FIG. 7 shows a configuration where the user is notified of an attempt to install applications or programs not consistent with the owner's criteria and can override those criteria. FIG. 8 shows an example of a configuration where a user may install non-compliant applications or programs, but the owner is notified when this happens. FIG. 9 shows an example where the master program not only blocks installation of non-compliant applications or programs but notifies the owner when the user attempts such an installation.

Process for Application and Program Vendors

The creation of a privileged portal for distribution of applications and software is described above in terms of how an owner or user of a mobile device or personal computer would use the portal with a “master program” to better control content on his or her device. Vendors⁶ must also interact with this portal in an active or passive manner. The applications or programs that users wish to download are made available on or through the portal. The information needed to determine compliance with owner/user criteria must be populated on the portal. Finally, this information must be maintained, verified, and updated on the portal. ⁶ The term “vendor” here is used in broad sense to include any party offering applications or programs for distribution to owners and users of mobile devices and personal computers. This includes those offering such software for purchase or at no direct monetary cost to the owner or user (i.e. free without conditions, free with advertising or other conditions, etc.). Vendors may be software developers themselves, entities that have purchased the rights to such software, intermediaries representing developers or owners, or other sorts of intermediaries.

A privileged portal may make applications or programs available in a number or ways. One such way is to have the software available for download on the privileged portal directly. If the application or program is for sale rather than being distributed without direct cost, the portal collects such funds from the owner/user just as any other online store or device family specific portal does. The privileged portal may collect fees, commission, or other monies from both the sale of software and software being delivered without direct cost. An alternative method is for the privileged portal to provide links to other, existing portals through which the software may be downloaded. For “flow-though” access to downloads available elsewhere, the privileged portal may collect a commission or referral fee from the existing portal. When a “flow-through” method is used, the destination portal restricts access in a way similar to the access that would be granted (based on owner/user preferences) to software directly available on the privileged portal. This arrangement will require either cooperation by the non-privileged portal that offers the software or an interface on the privileged portal which completes download transactions on the non-privileged portal (with the payment info, etc. “flowing through” to the non-privileged site as the software flows back through the privileged site to the mobile device or personal computer. Some combination of direct and “flow-through” distribution may be used on a single privileged portal.

There are also various ways in which the information on each program, the variables on which owners or users base their criteria for compliant software, can be populated or maintained in several ways. In one way, the privileged portal uses information from a third-party rating system. The organizers of the third party rating system are entirely responsible for producing and maintaining the data about the applications and programs they cover. In this case, the privileged portal is a tool for owners to impose their preferences on ratings from the third-party source on the applications or programs downloaded to their device. The privileged portal may either have a copy, updated regularly, of the ratings from the third-party rating system or may query that system every time an owner/user searches for applications meeting criteria generated from the rating system.

A more complicated method of populating and maintaining information to be used by owners and users in making download decisions is to create, maintain, update, and verify information collected for or by the privileged portal itself. Because of the multitude of applications and programs, and because of the opacity and complexity of the inner workings of such code, a primary method of collecting such information is self-reporting by code developers (or their agent or representatives), or, to a lesser extent, subsequent owners of rights to distribute such code. Such a process can be supplemented and complemented by random code evaluations carried out on behalf of the privileged portal, by a tip line to collect owner/user observations that are inconsistent with self-rating, by comparisons carried out on behalf of the privileged portal of self-reported data and independent ratings of the same data, a requirement that vendors provide advanced notice before changes are made in the application or program describing the purpose of the change and a recertification or revision of the self-reported data provided originally to the privileged portal, and portal sponsored change detection processes to discover undeclared changes to the code in applications and programs. A privileged portal may also outright require or proscribe the use of certain coding modules or use the presence, sole presence, or absence of such modules as one component of rating data to be drawn upon by the owner/user. A combination of self-reporting and manual or automatic code evaluation may help verify such information. A vendor of applications or programs may be required to enter into a contractual relationship with the privileged portal requiring accurate self-reporting, pre-notification of changes, or other reporting or coding requirements as a condition of having its applications or programs available through the privileged portal.

A hybrid possibility is making both external rating system data as well as privileged portal generated and maintained data available to the owner/user in setting criteria for his or her device.

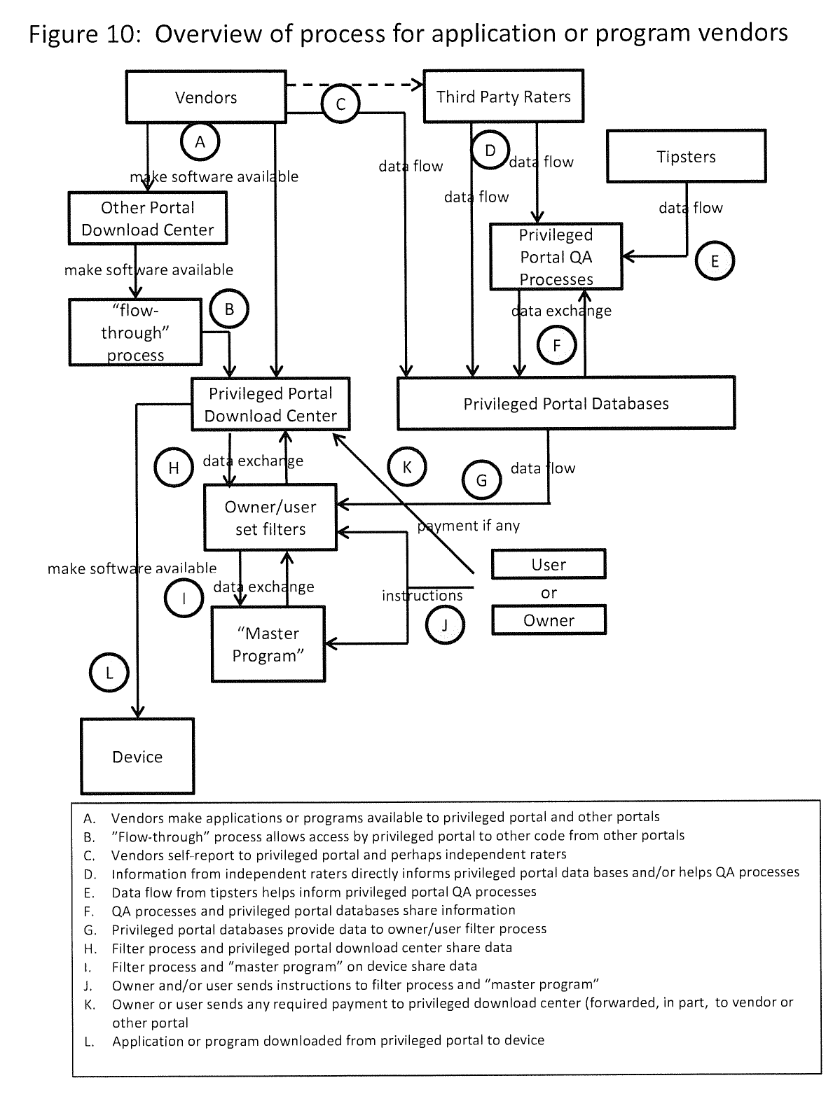

FIG. 10 shows an overview of the process for vendors of applications or programs.

The above detailed description is provided to illustrate specific embodiments of the present invention and is not intended to be limiting. Numerous modifications and variations within the scope of the present invention are possible. The present invention is set forth in the accompanying claims.

What is claimed is:

1. A method at a privileged portal, comprising:
receiving from a user or an owner of a computational device preferences relating to installing applications or programs on the device; and
linking of a rating system for software with the preferences so as to provide one or more custom filters that participates in installation of such applications or programs on the device.

2. The method of claim 1, further comprising installing a master program on the device, wherein the master program manages the download and installation of applications or programs on the device and sets up a privileged relationship between the privileged portal and the device.

3. The method of claim 1, wherein the custom filters are implemented on an online application or program portal through
a. hiding of applications or programs which are not compliant with the preferences;
b. disabling of applications or programs which are not compliant with the preferences; and
c. highlighting of applications or programs which are not compliant with the preferences.

4. The method of claim 3, wherein the privileged portal or the master program on the device take one or more of the following actions when a user of the device attempts to download non-compliant applications or programs:
d. blocking a non-compliant download;
e. Alerting the user of an attempted non-compliant download;
f. Requiring a further action by the user to complete download;
g. notifying the owner of an attempted or completed non-compliant download;
h. blocking and notifying the owner of an attempted non-compliant download; and
i. alerting the user and the notifying owner of the non-compliant download.

5. The method of claim 3. wherein the master program restricts application or program downloads to a privileged portal by one or more of the following means:
a. blocking a download from an unauthorized source which is other than the privileged portal or an authorized source;
b. alerting the user when a download is attempted or completed from the unauthorized sources; and
c. notifying the owner when a download attempt is made or is completed from the unauthorized source.

6. The method of claim 3, wherein the master program which monitors installed software to ensure it currently meets criteria set by the user or the owner and wherein, when non-compliant software is found, the master program does one of the following:
a. disables or removes that application or program from the device; and
b. notifies the user or the owner and provides an option to disable or remove that application or program.

7. The method of claim 3, further comprising implementing a flow-through process which allows download of an application or program through a portal other than the privileged portal based on criteria applied at the privileged portal.

8. The method of claim 1, further comprising implementing a contractual arrangement process in which code vendor and the privileged portal agree upon accuracy of self-reported data, requirements for pre-notification of changes, and a requirement for recertification or amendment to self-reported data.

9. The method of claim 8, wherein the rating system is one of a number of third-party rating systems that adhere a common rating criteria and which compare the common rating criteria to self-reported data in quality assurance process

10. The method of claim 8, wherein a change detection program monitors compliance with change pre-notification requirements.

11. The method of claim 1, wherein the rating system complies with an accepted coding standard.
